(19) United States
(12) Patent Application Publication
(10) Pub. No.: US 2018/0202852 A1
(43) Pub. Date: Jul. 19, 2018

(54) MEASURING DEVICE, METHOD AND SYSTEM

(71) Applicants: Gurjit DHALLU, Grays (GB); Sheeba KUKREJA, Grays (GB)

(72) Inventors: Gurjit DHALLU, Grays (GB); Sheeba KUKREJA, Grays (GB)

(21) Appl. No.: 15/742,300

(22) PCT Filed: Jul. 7, 2016
(86) PCT No.: PCT/GB2016/052043

§ 371 Date: Jan. 5, 2018

(30) Foreign Application Priority Data
Jul. 7, 2015 (GB) 1511860.7

(51) Int. Cl. G01F 19/00

(52) U.S. Cl. CPC G01F 19/002

(57) ABSTRACT

A computer-implemented method for obtaining a setting for measurement of a substance using an adjustable measuring device is provided. The method comprises receiving a user input relating to a required amount of an ingredient X concentration level or a serving size of a dry substance Y. The method further comprises calculating a setting for the adjustable measuring device based on the received user input and stored information relating to calibration of the device with the substance. The method also comprises outputting or displaying data relating to the setting to be used for the adjustable measuring device. A system comprising an adjustable measuring device (10) for measuring an amount of a substance and a processing device configured to execute the method is also provided. A computer program is further provided, configured to, when executed on a computing device, cause the computing device to perform the method.

### TECHNICAL FIELD

The present invention relates to an adjustable measuring device for measuring a quantity of a substance, and in particular a dry substance, placed therein. The present invention relates to a method of and system for measuring a dry substance.

### BACKGROUND TO THE INVENTION

Measuring an amount of a dry substance such as a foodstuff can be achieved in different ways. For example, the foodstuff can be weighed on a scale. Alternatively, the foodstuff can be placed in a measuring device provided with or without markings to enable an amount of contents placed therein to be determined. For the latter, conventional measuring devices such as plastic scoops only provide the user with an approximate estimated measure of an ingredient concentration or a weight serving size of a dry substance. They do not take into account the weight and density of different types of dry substances, which can vary significantly e.g. between a fine powder and a coarse grain. Putting coffee or dry milk powder into a 70 cc scoop for example, may not accurately measure a user specified level of coffee or milk powder because of the differences in the physical properties of the two substances.

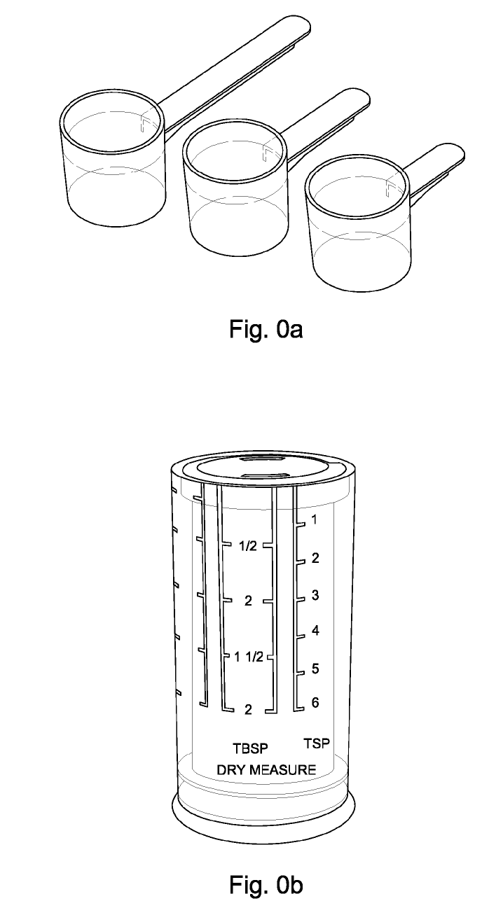

Measuring devices such as fixed measure plastic scoops, e.g. as shown in FIG. 0(a) are, by and large, an inaccurate and inconsistent way of measuring dry substances. Inaccurate and inconsistent measurements of dry substances may increase the chance of wastage and overconsumption.

Continuous and regular large amounts of wastage and overconsumption of dry substances can lead to a number of issues to both consumers and businesses. For consumers, this could increase health problems. For example, a consumer who is diagnosed with renal disorder may need to control his or her protein consumption and may wish to use different protein concentration levels in protein supplement shakes. Conventional plastic scoops could increase the likelihood of further complicating health problems through inaccurate and inconsistent multiple serving measures and lead to overconsumption of protein supplement powder.

Additionally regular overconsumption and wastage using conventional measuring devices can lead to faster consumption of dry substances and therefore requiring the consumer to purchase dry substances more frequently. This can lead to cost implications.

Another major problem of using conventional measuring devices such as plastic scoops is that the end user has no control whatsoever in choosing different ingredient concentration levels or the serving weight sizes of the dry substance. This is particularly an issue with many retail products such as sport nutritional supplements where the manufacturer specifies a suggested serving size on the product label. The suggested serving size is an approximate measure based on the size of the enclosed fixed measure plastic scoop with the product. The consumer has no control over choosing different required levels of ingredient concentration or serving weight dosage of a dry substance. These measures are not designed for this purpose. The consumer can only guess the level of ingredient concentration level required or serving weight size of the dry substance. This can further increase the likelihood of increased wastage and overconsumption of dry substances via trial and error.

Conventional plastic scoops are available in various fixed size measures ranging anything from 0.5 cc to over 100 cc. For businesses, this has major cost implications in that several different scoop sizes are required to be manufactured in order to cater for a wide variety of different consumers and industries. For example, the sports supplement industry requires many different sized scoops to cater to different type of products as may the catering or health industry do. Additionally every product is likely to be packaged in different size containers or packaging as well so there is no one size fits all for these measuring devices. The need to manufacture several different size and types of plastic scoops leads to high manufacturing costs.

For consumers there is also the problem of limited flexibility and choice when it comes to using a particular sized plastic scoop measure from one dry substances product to another. The underlying issue remains in that these measuring devices do not take into account the weight and density of different types of dry substances which can lead to inaccurate and inconsistent measures of ingredient concentrations or serving weight sizes of the dry substances.

The inaccuracies and inconsistencies of measures using conventional plastic scoops can also lead to misrepresentation and inaccurate information being specified on dry substance products like nutritional supplement products. Many nutritional supplement products specify serving per container details on the product label. The serving per container data is based on the manufacturers specified serving suggestion size. If the suggested serving size is inaccurate in the first place due to inaccurate and inconsistent measures of ingredient concentration or serving size using the scoops, the specified servings per container data are highly likely to be incorrect and misleading.

Adjustable measuring cups, such as that shown in FIG. 0(b) are also known. The example shown comprises a central plunger within an outer sleeve. The plunger is axially moveable within the sleeve. The plunger is enlarged at the lower end, to retain the sleeve thereon. The opposite end comprises a flexible cap of similar diameter to the inner diameter of the sleeve such that the plunger can move therein. Movement of the plunger within the sleeve can, however, be erratic, with the cap prone to sticking or catching. The device is also found not to be able to provide accurate measurements of dried foods placed therein. Adjusting the base up to the 0.25 oz mark in the device for example may not accurately measure 0.25 oz of dry milk powder or a protein supplement powder because the density of each of these type of dry substances are not only unknown but will vary from one another. Additionally it is known that this type of measuring devices commonly have tapering or draft on its side walls or walls so the top and bottom ends of the cylinder shaped device body are not parallel, hence the measurements of dry substances will not be accurate.

Aspects and embodiments of the present invention have been devised with the foregoing in mind, and aim to improve upon existing measuring devices

### SUMMARY OF THE INVENTION

According to a first aspect of the present invention there is provided a computer-implemented method for obtaining a setting for measurement of a substance using an adjustable measuring device as defined in claim 1. The steps included in claim 1 and the calculations are preferably all performed within a software application located locally on a user device. The calculations are done automatically by the application, based formulae described in detail later on and on information relating to the size of the measuring device as well as the data inputted by the user on the dry substance to be used with the measuring device.

According to a second aspect of the present invention there is provided a system comprising an adjustable measuring device as defined in claim 8. The method of the first aspect may use the device of the second aspect. According to another aspect there is provided a computer-implemented method for obtaining a setting for measurement of a substance using an adjustable measuring device. The method may comprise receiving user input relating to a required amount of an ingredient X concentration level or a serving size of a dry substance Y, calculating a setting for the adjustable measuring device based on the received user input and stored information relating to calibration of the device with the substance, and outputting or displaying data relating to the setting to be used for the adjustable measuring device.

According to a third aspect of the present invention there is provided a computer program as defined in claim 17. The computer program may facilitate performing the method of the first aspect.

Aspects and embodiments of the invention relate to an arrangement that advantageously provides a measuring device that overcomes the problems associated with conventional measuring scoops and devices described above. The device can accurately measure a quantity of a substance, taking into account physical properties of the substance such as the density and granule size etc. Aspects and embodiments of the invention are particularly useful to provide a serving weight size of a dry substance Y or an ingredient concentration level X within a dry substance Y, taking into account the weight and density of different types of dry substances, which can vary significantly. References to “dry substance Y” are to any dry substance, e.g. a foodstuff, nutritional supplement powders or medical or veterinary product, and can include fine or coarse grade powders and larger grains or granules. References to “ingredient concentration level X” are to a component within a dry substance Y that is provided in a certain amount or at a certain concentration level. E.g. a spoonful (about 5 g) of instant coffee granules (dry substance Y) contains about 60 mg of caffeine (ingredient concentration level X).

The measuring device has an inner volume and/or area the dimensions of which are consistent and equal from one end to the other. This is achieved by having no draft on the inner side walls of the measuring device interior.

The body and plunger are preferably cylindrical in shape. The shape of the measuring device may instead be cubical, rectangular, cylindrical or otherwise (regular or irregular shape) so long as all the side walls of the measuring device are parallel with no draft or tapering. The plunger may be formed of a rigid plastics material. In an embodiment, the plunger is of a unitary construction, or it may be of a two-piece construction e.g. comprising a body having a cavity and an insert receivable within the cavity. The outer surface of the plunger may comprise one or more formations configured to provide an interference fit with the inner surface or surfaces of the device body to facilitate movement in the axial direction. These formations may provide relatively raised and lower portions such that only certain parts of the exterior of the plunger walls contact the interior of the device body. In an embodiment, the one or more formations comprise one or more ridges or grooves along the outer surface thereof extending in the axial and/or perpendicular and/or other direction. Advantageously, the moveable plunger or base is sturdy, stable and offers slick movement during use with or without the contents of dry substance Y.

The measuring device may further comprise a handle. This may be an outwardly projecting open handle or arm or a more conventional closed handle. The device may further comprise a first set of measuring marks on a first portion of the exterior of the body and a second set of measuring marks on a second portion of the exterior of the body, the first and second portions being diametrically opposite each other and either side of the handle. The first set of measuring marks may comprise even numbers and the second set of measuring marks may comprise odd numbers. The measuring marks may each comprise a line perpendicular to the axial direction, the lines each having a predefined thickness. The markings may not correspond to actual weight markings, but provide a relative scale which, when used in conjunction with one or more of the methods described herein, provide a relative measuring scale that accurately provides for accurately measuring an amount of a dry substance, the amount being determined by the said method(s).

The incremental marking lines on the measuring device are designed accurately and are provided at a distance that is as narrow as possible between each marking line. This is achieved by having set of marking lines on two opposing surfaces of the measuring device. This gives greater accuracy in measures of various types of dry substance Y so long as a calibration or collaboration process of each type of dry substance Y is performed using a weighing device or scale which will take into account the weight and density of dry substance Y. A weighing device or scale may be in the form of a manual (non-digital) or digital scale, a computerised or non-computerised implemented mechanism or device, or may be of an electronic or non-electronic mechanism device or software application which has the ability to weigh the dry substance Y and perform the said collaboration process as described below. The device may be a mobile phone, wearable, watch, tablet, laptop, or other personal electronic and/or computing or processing device. The device may comprise a pressure-sensitive surface e.g. a mobile phone, wearable or other device may comprise a pressure-sensitive screen. The weighing device may work in tandem with a web page or any other form of software language in order to weigh the dry substance Y and perform the said collaboration process as described below.

The measuring device may be used in conjunction with a software application executable on a computing or processing device. This is intended to be construed broadly, and to cover personal and mobile computing devices as well as other intelligent devices comprising a processing means. The software may be accessible by a user on any appropriate computing or processing device such as a mobile phone, wearable, watch, tablet, laptop or other personal electronic and/or computing device. The software application including any saved data generated by the software application may be stored on locally or remotely from the computing or processing device (e.g. in a cloud or other storage means, online or otherwise), and may be accessed via the internet or otherwise. The system may comprise a display means and/or user interface for displaying the outputted data and for enabling input by a user.

The computing or processing device may be configured to host instructions for enabling processing of the input data. The system may have an input/output data interface. The system may include a processor, a storage device, and a non-transient machine-readable storage medium. The machine-readable storage medium may include instructions which control how the processor receives input data and transforms the input data (the electrical signal) into output data e.g. on the screen, a connected printing device or via an audio output. The machine-readable storage medium in an alternate example embodiment is a non-transient computer-readable storage medium.

The computer-implemented method can be used to obtain a relevant marking to use on the measuring device so that an accurate amount of the dry substance being measured can be obtained, taking into account the density of the substance. This is achieved by first calibrating the device. The calibration or collaboration involves receiving user input comprising the specifications of the dry substance as well as the collaboration weight of a predetermined amount of the dry substance calculated by zeroing a weighing device (tare function) with the adjustable device placed thereon when empty, and then weighing the adjustable measuring device when filled to a predetermined level with the dry substance, or by determining the weight difference between the adjustable device when empty with the adjustable device when filled to a predetermined level with the dry substance. Weighing the adjustable device when empty and when filled to a predetermined level with the dry substance can be done using a weighing scale or device.

In an embodiment, the user input comprises one or more of the name of a dry substance Y, the net weight of the substance Y, a calibration weight, the ingredient X concentration level and its relative actual weight. The method may further comprise inputting or selecting a required weight serving size of substance Y or a required concentration level of ingredient X in substance Y. Outputting or displaying the data relating to the setting to be used for the adjustable measuring device may comprise outputting or displaying a value corresponding to a measuring mark that is provided on the adjustable measuring device. Additionally or alternatively it may comprise outputting or displaying a symbol indicative of an orientation in which the measuring device must be used. Outputting or displaying a symbol may also comprise indicating whether the adjustable measuring device should be fully or partially filled. Outputting or displaying the data relating to the setting to be used for the adjustable measuring device may comprise outputting or displaying a plurality of values and/or symbols where the serving weight size amount or ingredient X concentration required of substance Y equates to less than or more than one full measuring device.

In an embodiment, the method further comprises calibrating the adjustable device by receiving user input relating to a dry substance Y. The user input may comprise one or more specifications of the substance Y and a calibration weight of a predetermined amount of the substance calculated by zeroing a weight of the measuring device with a weighing device or scale when empty. The method may further comprise weighing the adjustable device when filled to a predetermined level with the substance, or by determining the weight difference between said adjustable device with said adjustable device when filled to a predetermined level with the substance.

In an embodiment, a computer program is provided which, when run on the computing or processing device, causes the computer to perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software implementation may be an assembly program.

The computer program may be provided on a computer readable medium, which may be a physical computer readable medium, such as a disc or a memory device, or may be embodied as a transient signal. Such a transient signal may be a network download, including an internet download. The computer program may be configured to, when execute, carry out the method(s) or processes described herein.

Use of the measuring device with the software application and a weighing device or scale advantageously enables a user to measure multiple ingredient concentration X levels and serving weight sizes of various dry substances accurately and consistently. This can be useful for measuring an amount of a substance so it includes a known concentration of ingredients such as caffeine, protein or carbohydrate concentrations. There are also medical applications e.g. to measure the concentration of methylcellulose powder concentrations or phenylbutazone powder concentrations in veterinary medicine. It can also be useful to measure an amount of a dry foodstuff such as coffee, wholegrains, nutritional supplements etc.

The weighing device or scale can be incorporated into or part of the measuring device. Alternatively, the measuring device may be connectable to a weighing device or scale. In such embodiments, the weight results can be automatically provided from the weighing device or scale into the software application. Alternatively, the weighing device or scale can be separate and the weight results obtained therefrom manually entered into the software application. The device may be a mobile phone, wearable, watch, tablet, laptop, or other personal electronic and/or computing or processing device. The device may comprise a pressure-sensitive surface e.g. a mobile phone, wearable or other device may comprise a pressure-sensitive screen. The weighing device may work in tandem with a web page or any other form of software language in order to weigh the dry substance Y and perform the collaboration process.

Once the measuring device has undergone a calibration or collaboration process with dry substance Y, the software application enables the end user to select or enter the required data relating to dry substance Y and select data relating to their consumption needs of ingredient X concentrations or serving weight sizes relating to a dry substance Y. The software application can incorporate any size (height of the measurable area) of the measuring device and generate output data which indicates to the user how much adjustment is required of the moveable adjustable base inside the measuring device in order to give the user their predetermined level of ingredient X concentrations or serving weight sizes of a dry substance Y (once filled with the required contents) accurately and consistently.

The measuring device can be provided in different sizes depending on the intended use. The software app may take the size, or an indication thereof, as an input from a user in order to differentiate between and select appropriate data for use in calculations.

It has been found that using conventional plastic scoops leads to inaccuracies and inconsistencies of measurements of ingredient X concentrations and serving weight sizes of dry substance Y which has potential repercussions in terms of lack of safety (poor controlled measures) in powdered nutritional supplements and medicine products. Performance test data obtained supports this and demonstrates the superiority of the present measuring device to give a user far greater control, accuracy and consistency in multiple measures of ingredient X concentrations and serving weight sizes of dry substance. Additionally the present measuring device overcomes the limitations of plastic scoops and other types of measuring devices as well as providing the user with many enhanced benefits as discussed herein.

Additionally the enhanced features of the software application together with the measuring device helps the user in many ways in achieving their needs such as providing cost effective solutions relating to dry substance Y before or after purchase of a product.

The principles outlined herein demonstrate that what sets the present measuring device apart from other measuring devices currently available in the market is the ability to account for the density and weight of a dry substance Y. If this is not done, it is likely ultimately to lead to inaccurate and inconsistent measures of ingredient X concentrations or serving weight sizes of various dry substances Y. This means that multiple predetermined levels of ingredient X concentrations or servings sizes relating to dry substance Y can be measured accurately and consistently as per a user's requirements. Aspects and embodiments of the invention therefore provide accuracy and consistency of measurements of ingredient concentrations and serving weight sizes in dry powdered and non-powdered substances, including foodstuffs. In addition, the device has unique characteristics in terms of the physical construction and the properties of the moveable (plunger) adjustable base.

Additional benefits of aspects and embodiments of the invention include the following:
One measuring device can be used with many different types of dry substance Y in measuring ingredient X concentrations or serving weight sizes accurately and consistently, rather than using different sized measuring devices
Sharing of collaboration data of dry substances between many users. This eliminates the need for some users to perform the collaboration process as long as the same dry substances are used
Increased safety from controlled dosages of dry substances
Reduces the risk of over and under consumption of the ingredient X concentrations and serving sizes of dry substance Y
Reduces or eliminates wastage of ingredient X concentrations and serving sizes of dry substance Y
Greater accuracy and consistency of measures of many ingredient X concentration levels and serving weight sizes of dry substance Y which can assist users by saving money and maximise the benefits of dry substance Y
Can be used to assist users requiring carefully controlled consumption of dry substance Y
Reduced costs for businesses. Less requirement to manufacture many different sized measures.
Increased production efficiencies for businesses specialising in the packaging of various dry substance Y products in poly bags, pouches, cello bags etc. which can be achieved through accurate and consistent measures
Perfect for travellers or users that are constantly on the go and require accurate and consistent measures relating to various types of dry substances
Reduce storage space and less clutter as less different sizes measuring devices required in households and for businesses.
Practical, easy to use and a user friendly software application

Aspects and embodiments of the invention are particularly suited for use in measuring dry substances, but it may also be possible to use the device to measure wet substances (i.e. anything that is not “dry” as discussed above). A rigid or flexible sealing means may be provided around one or more edges of the plunger if required (although the one or two-part rigid construction described above is advantageously simple and convenient).

Features which are described in the context of separate aspects and embodiments of the invention may be used together and/or be interchangeable. Similarly, where features are, for brevity, described in the context of a single embodiment, these may also be provided separately or in any suitable sub-combination. Features described in connection with the device may have corresponding features definable with respect to the method(s) and computer program and these embodiments are specifically envisaged.

Embodiments of the invention will now be described with reference to the Figures of the accompanying drawings in which:

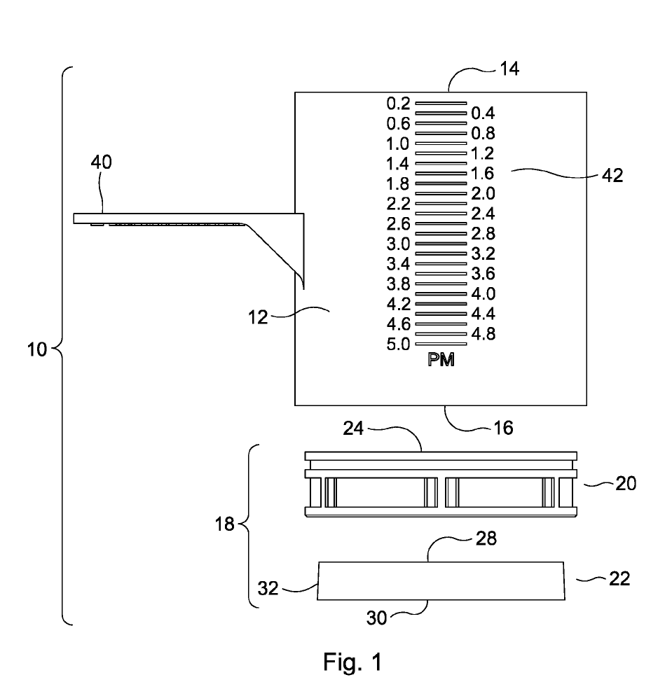

FIG. 1 shows a side exploded view of a measuring device according to an embodiment of the invention;

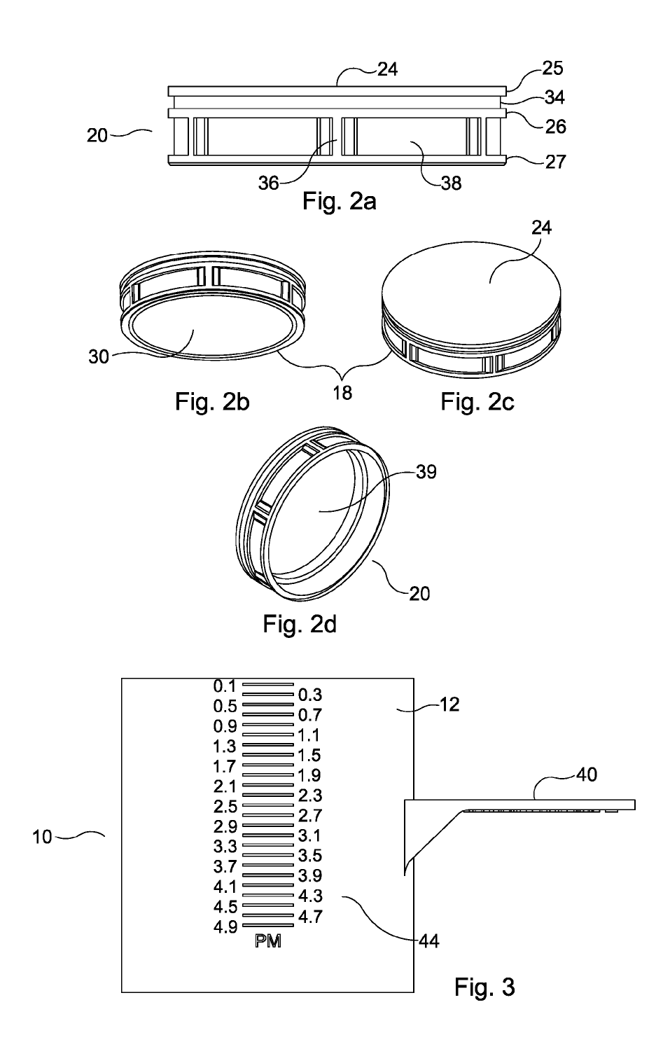

FIGS. 2a to d show a perspective view of a plunger as used in the embodiment of FIG. 1;

FIG. 3 shows a side view of the device body in accordance with the embodiment of FIG. 1;

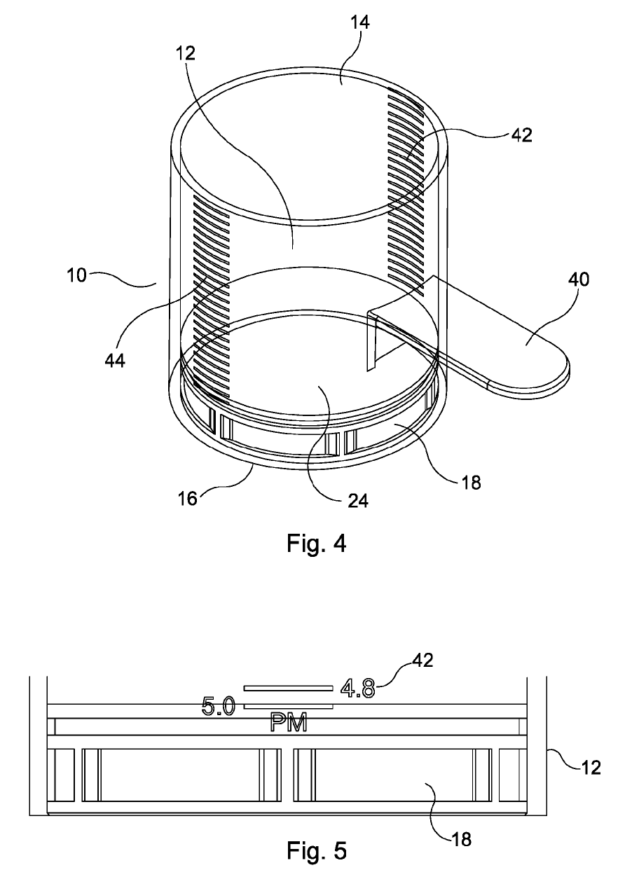

FIG. 4 shows a perspective view of the measuring device of FIG. 1;

FIG. 5 shows a partial side view of the embodiment of FIG. 1;

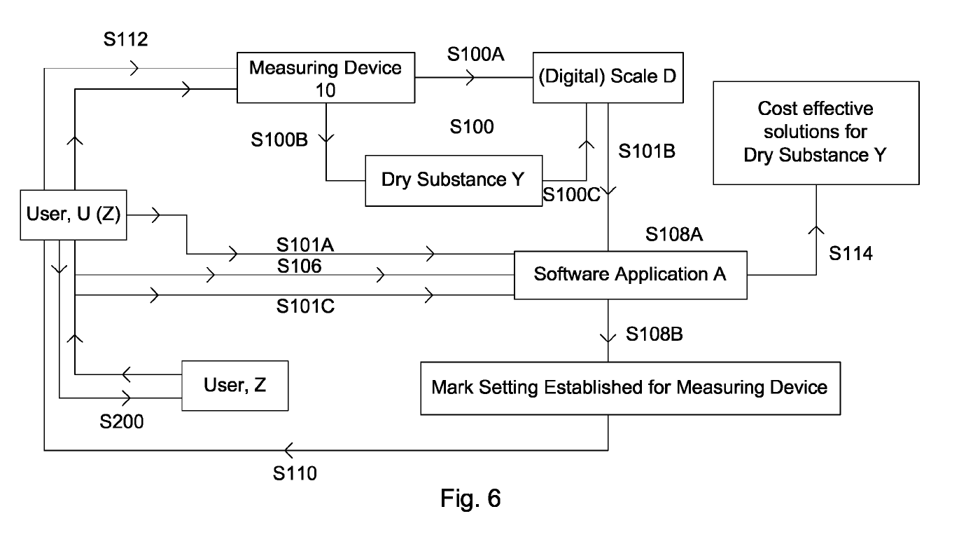

FIG. 6 shows an overview of a system incorporating a measuring device according to an embodiment of the invention;

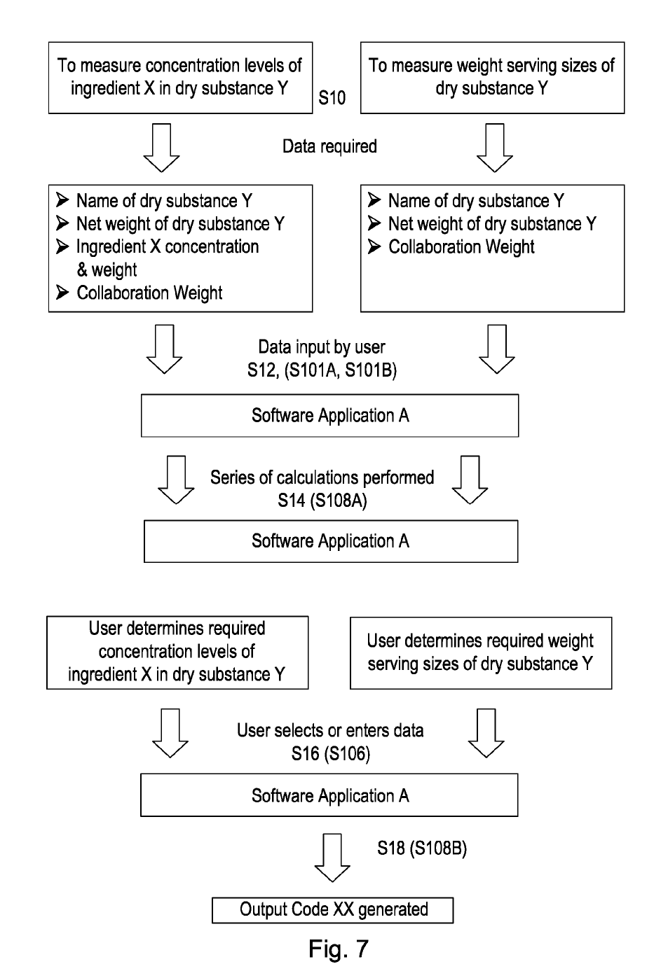

FIG. 7 depicts a process for obtaining measurement information using the system of FIG. 6;

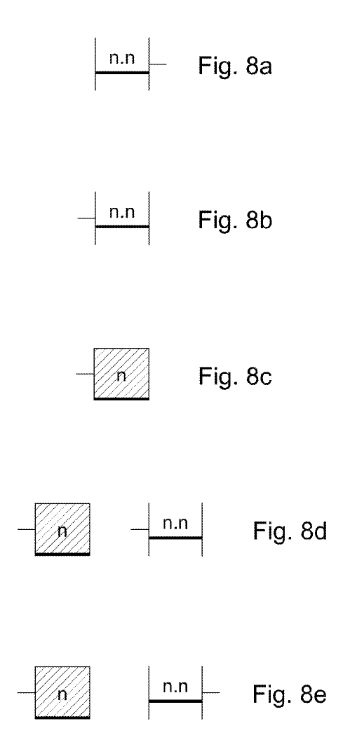

FIG. 8 shows indications of measurements achieved using an embodiment of the present invention; and

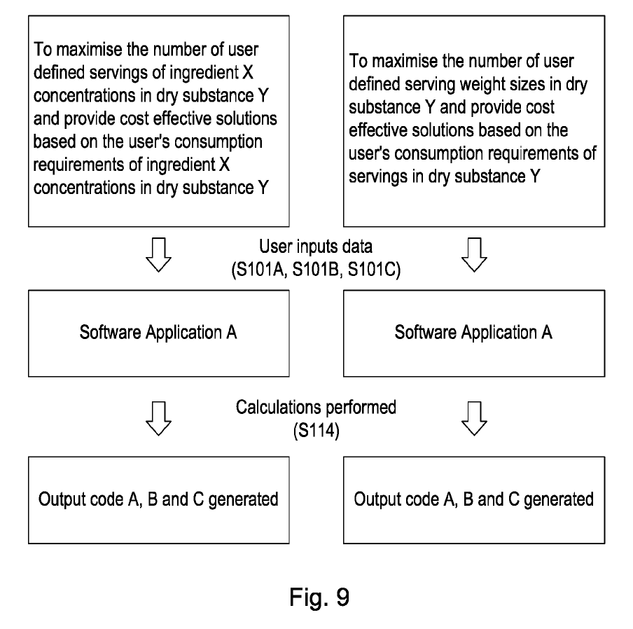

FIG. 9 shows a process for obtaining information using the system of FIG. 6.

### DETAILED DESCRIPTION OF EMBODIMENTS OF THE INVENTION

As used herein, an ingredient will be referred to as ingredient X which is a variable and a dry substance will be referred to as dry substance Y which is also a variable. Aspects and embodiments of the invention can be used to measure several different concentration levels of ingredient X in dry substance Y as per the user's requirements. For example, 15 g of caffeine (ingredient X) concentration in coffee (dry substance Y). Aspects and embodiments of the invention also provide for measuring several different weight serving sizes in dry substance Y as per a user's requirements, for example 30 g of milk powder (dry substance Y).

FIGS. 1 to 5 show a measuring device according to an embodiment of the invention. The measuring device is a container 10, e.g. a cup or scoop. The container 10 comprises a tubular body 12 having open ends 14 and 16. In a preferred embodiment, the body 12 is a cylindrical tube manufactured with substantially zero draft such that the inner diameter of the body 10 is constant along the axial length of the body 12 without any tapering.

A first or upper end 14, and/or a second or lower end 16, is open to permit contents, e.g. foodstuffs, to be placed therein and/or to receive a plunger 18.

The plunger 18 is configured to have a tight interference fit within the open end 16 (or 14) of the scoop body 12. In the embodiment shown, the plunger 18 comprises a plunger body 20. The plunger body 20 comprises a top or major surface 24 and generally cylindrical sidewalls 25, 26 and 27. The plunger body 20 is preferably integrally formed and provides a cup like container having a cavity defined by the inner surface of the plunger body top 24 and the sidewalls 25, 26 and 27. A plunger insert or dome 22 is receivable within the cavity. The insert 22 is generally frustoconical with first and second opposing surfaces 28, 30 separated and joined by a tapering sidewall 32. The insert surface 30 that sits outermost when inserted into the plunger body 20 is of a slightly larger diameter than the opposing surface 28. The sidewall 32 of the plunger insert 22 is smooth in the embodiment shown. Alternatively, the sidewall 32 may be configured and/or provided with features or formations configured to co-operate or interengage with corresponding features provided on the interior of the plunger body sidewalls 25, 26 and 27. The outer surface of the plunger insert 30 may be concave, which may help provide better smoother movement when used and provide more leverage for those users with smaller fingers. In an alternative embodiment, however, this may instead be flat, convex or otherwise. In an alternative embodiment, the plunger 18 is of a single piece or unitary construction and/or may just consist of the plunger body 20.

The exterior of the sidewalls 25, 26 and 27 of the plunger body 20 are configured or textured to provide structural rigidity and to help locate and secure the plunger 18 within the scoop body 12. In the embodiment shown, a groove or indentation 34 is provided encircling the periphery of the plunger body 20. In an alternative embodiment, additional grooves could be provided axially spaced from the groove 34. In an embodiment, the groove(s) only extend around a part of the exterior of the plunger body 20 or intermittently extend therearound. A plurality of axially extending ridges 36 are provided around the exterior of the plunger body 20. In the embodiment shown there are six, but it will be appreciated that fewer or more may be provided, or just a single ridge could be employed. Between the ridges 36 are troughs 38. The troughs 38 are effectively another peripherally extending groove or channel, with discontinuous ridges 38 provided at intervals therealong. In an alternative embodiment the sidewall 26 could be positioned in the middle centrally between sidewall 25 and 27 and a total of twelve ridges 36 could be provided around the exterior of the plunger body 20 with extra troughs 38 and without a groove or indention 34 encircling around the periphery of the plunger body 20.

The combination of circumferentially and axially extending sidewalls and/or ridges provides strength and rigidity in both of these directions. The plunger body 20 is preferably fabricated such that all parts of the plunger body 20 apart from the grooves 34, 38 extend to the same radial distance. This means that all parts of the plunger body 20 (again apart from the grooves 34, 38) will contact the parallel inner surfaces of the scoop body 12. This ensures the plunger 18 is always in axial alignment with the scoop body 12 and that the top surface 24 of the plunger 18 remains perpendicular to the axial direction (i.e. horizontal when the measuring device is placed on a surface). The plunger 18 thus provides an adjustable base axially moveable within the scoop body 12 to provide measurements of dry substances placed therein, as will be described below.

The scoop body 12 is further provided with a handle 40. The handle 40 extends radially outwardly from the scoop body 12. In the embodiment shown the handle 40 is a simple planar projection having a first end attached to the scoop body 12 and an opposite free end. It will however be appreciated that handles of other forms could be used, e.g. a conventional handle where both ends are joined, in axial alignment, to the body 12. In other embodiments (not shown) the handle is omitted. A marking, projection, indentation or other indicator may additionally be provided or used instead of the handle. This is because the handle 40 has a dual purpose, as is discussed in more detail below.

The scoop body 12 is formed of a transparent or semi-transparent material that permits viewing of the contents therein from the exterior of the scoop body 12. The scoop body 12 may be formed of a plastics material or glass. The plunger 18 is preferably formed of a non-transparent material, or at least of a material of a different opacity to that of the scoop body 12, such that the sidewalls 25, 26 and 27 are distinguishable when viewed through the walls of the scoop body 12.

The adjustable base 18 is made using a thermoplastic elastomer type material with a polyolefin type material. A thermoplastic type material may be (but not limited to) a Styrene Ethylene Butylene Styrene (SEBS), Styrene-Ethylene/Propylene Styrene (SEPS) or Polyolefin Elastomers (POE). A polyolefin type material may be a crystalline polymer or resin such as (but not limited to) Random Copolymer Polypropylene, Homopolymer Polypropylene, High-density polyethylene (HDPE) or Low-density polyethylene (LDPE).

In an embodiment, the height of the scoop body 12 is substantially 62.75 mm, the internal diameter is 54.00 mm, the thickness is 2 mm meaning the external diameter is 58 mm. The device 12 may, however be of any size and may be smaller or larger as needed for various different applications or markets/industries.

For accuracy, the measuring device 10 must have very accurate and small incremental distances between each marking on the side walls of the device body 12. Additionally the distance from the top outer edge of the measuring device bowl and between each marking when all the markings on the device body 12 were to be or are in combined state must be as small as possible. The smaller the incremental distances between each marking and from the top outer edge of the measuring device bowl and in combined state on the measuring device, the more accurate the measuring device will be in measuring concentration levels of ingredient X or serving weight sizes of dry substance Y. The larger or greater the incremental distance between each marking and from the top outer edge of the measuring device bowl and in combined state on the measuring device, the less accurate the measuring device will be in measuring concentration levels of ingredient X or serving weight sizes of dry substance Y.

Measurement markers are provided on the scoop body 12 to provide an indication of the amount of contents placed therein. In order to achieve very accurate and smaller incremental distances between each marking on the measuring device 10 the scoop body 12 is provided with two set of numbers, markings and/or characters.

In the embodiment shown, a first set of markers or measures 42 is provided in a first location on the exterior of the scoop body 12, and a second set of measures 44 is provided in a second location on the exterior of the scoop body 12 that is diametrically opposite the first location. Preferably the first and second measurement markings 42, 44 are provided either side of the handle 40, i.e. such that the centre of the first set of markings 42 is located approximately 90° from the centre of the handle 40 in one direction and the centre of the second set of markings 44 is located approximately 90° from the centre of the handle 40 in the opposite direction. The markings may be moulded, embossed, engraved, printed or otherwise provided on the outer surface area of the scoop body 12.

For accuracy and consistency, one position of each marker line M is used to denote the reference point against which measurements are made, e.g. the top edge of a substantially horizontal line. The first set of markings 42 provides even denominations and the second set 44 provides odd denominations. For example, in the embodiments shown, markings (“precision markings” or PM) are provided in increments of 0.2 with the first set showing denominations 0.2, 0.4, 0.6, etc. and the second set showing 0.1, 0.3, 0.5 etc. Each marker line M in the first set is positioned at a distance of 2 mm from the top edge of the marker line below it, with the uppermost marker being positioned 2 mm from the top edge of the cup body 12. Each marker line M in the second set is positioned at a distance of 2 mm from the top edge of the marker line below it, with the uppermost marker being positioned 1 mm from the top of the cup body 12. Similarly, when the plunger 18 is moved within the device body 12 when a measurement is needed, the same marker line reference is used, i.e. the top edge in the present embodiment, as exemplified in FIG. 5.

Preferably the distance between each marker line on the measuring device is as small as possible. In effect the markings from both the first and second set on device body 12 in combined state, the distance from the top edge of the cup body 12 and between the top edges of each marker below it is 1 mm.

In the embodiment shown each marker line M on device body 12 has a number assigned against it. The numbers represents the actual distance from the top outer edge of the measuring device bowl and the top edge of the markers lines below it. For example the marker line with number 3.0 assigned against it (first set markings) is 30 mm distance from the top outer edge of the measuring bowl and the top edge of this markers line. In an alternative embodiment each marker line M may have a graphical image(s), line(s), shape(s), diagram or letter(s) assigned against it in order to represent distances from the top outer edge of the measuring device bowl and the top edge of the markers lines below it.

In operation, a user can manually manipulate the base 18 to insert it into, move it within and remove it from the measuring body 12. As discussed above, the adjustable base 18 is designed in a way that is stable and sturdy inside the measuring device body 12 when it is aligned against any marker line M with or without dry substance Y contents inside the measuring device 10. The base 18 is designed to provide slick movement during use and the top area of the adjustable base has a flat and even surface.

The plunger dome 22, which works as an interference fit with the plunger component 20, forms the flooring for the adjustable base 18 and enables the user to place their fingers on the dome outer surface area 30 and to push the adjustable base in upward direction inside device body 12 in a more controlled motion. Alternatively the user could exclude dome 30 and place their fingers on the plunger inner bottom 39 and push the adjustable base in upward direction inside the device body 12.

If the measuring device is to be used to measure multiple ingredient X concentration levels or serving weight sizes of dry substance Y accurately and consistently as per the users requirements then the weight and density of that dry substance Y must be collaborated with the measuring device using a weighing device or scale.

A collaboration or calibration process can be performed that involves ascertaining the weight or density of dry substance Y whilst it is present inside the measuring device 10 by the user using a scale when the adjustable base 18 inside the measuring device 10 is in its default starting position. A “collaboration weight” is required, being the weight of a predetermined volume of dry substance Y within the measuring device 10 but not including the weight of the measuring device 10 itself. It is preferable and convenient for the “predetermined volume” to be a full, level measure but any amount of the dry substance Y inside the measuring device 10 could be weighed. The weight of the device 10 must be cancelled out so that only the weight of dry substance Y is ascertained using the weighing device. This is performed by placing the measuring device 10 with the adjustable base 18 inside the device 10 in its default starting position on a digital scale. The weight of the measuring device 10 must be cancelled out by ensuring that the displayed metric data on the scale is zero. The user fills the measuring device 10 with dry substance Y which must be levelled off (as best as possible by the user) from the top edge of the measuring device bowl and removing any excess amount of dry substance Y as necessary e.g. by using a straight edged object or otherwise. The measuring device 10 must then be placed back on the scale again so that the weight of the dry substance Y is ascertained. This collaboration method is a one off process that must be performed for each dry substance Y that is to be used with the measuring device 10 and when the full collaboration data is to be recorded in the software application A for the first time. The collaboration weight data can be entered into a software application A as will be discussed later. This collaboration or calibration data enables the density and or granule/grain size of the dry substance to be accounted for in the calculations performed by the software application A. The output from this process is a “collaboration weight” which is the weight, as measured on a weighing scale, of a predefined amount of the dry substance in question—e.g. a full, level scoop 10.

The default starting position of the adjustable base 18 inside the measuring device 10 is reached by aligning the top edge of the adjustable base 18 in the measuring device body 12 against the top edge of the marker line M that is aligned against the lower most marking (number 5.0 as shown in FIG. 5).

The scoop 10 can be used in conjunction with a software application A. This makes it possible, for a particular dry substance Y and a predetermined amount of ingredient X concentration level in dry substance Y or serving weight size from dry substance Y a user requires, for a user to be instructed on where to position the base 18 within the scoop body 12 in order to achieve the desired amount of a serving measure. A system overview is shown in FIG. 6; specific details and exemplary implementations are discussed later in relation to FIGS. 7 to 9.

Referring to FIG. 6, in step S100, using a measuring device 10 and scale D as described above in relation to FIG. 5, steps S100 (A, B & C) are performed to initiate the collaboration process as discussed above. Step S100A represents weighing an empty device 10 on scale D and zeroing out the weight of the device 10 (otherwise known as taring), S100B represents placing an amount of a dry substance Y in the device 10 and step S100C represents weighing the filled device 10 on scale D. The output reading(s) from the scale D are inputted to the software application A in step S101B. Additionally user U inputs some data relating to the specifications of a dry substance Y into the software application A in step S101A. This completes the full collaboration process of a dry substance Y with measuring device 10. Using the information from the collaboration process S101 (A & B), the software application A performs various calculations and stores the results in a database (S108A).

At any time after the collaboration process is complete, the user U can select data relating to the name of dry substance Y from the software application A and the desired concentration levels of ingredient X in dry substance Y or serving size of dry substance Y as per the user's requirements (S106).

The software application A performs various calculations and takes the information from the collaboration process S101 (A & B) and from step S106 in order to generate output data (S108B) that indicates to the user (step S110) the required setting on the measuring device 10. The user U, in step S112, manually adjusts the base 18 of the device 10 to the specified level in order to obtain the required quantity of dry substance Y. The software application A can also be used to perform calculations to provide indications of the cost effectiveness of different dry substances Y in step S114 providing that the user U inputs additional information relating to their consumption requirements and purchase details relating to dry substance Y (step S101C).

Generally speaking, therefore, where needed, the user U first needs to initiate the collaboration process. The user U inputs the specifications relating to the dry substance Y (e.g. information taken from food product labels etc.) into the software application A (S101A) and inputs the collaboration weight (S101B), once steps S100A, S100B and S100C are complete, into software application A. That completes the full collaboration process of the dry substance Y with the measuring device 10. Steps S100A, S100B and S100C are the physical processes that need to be performed first before the user can do S101B and S101A. Steps S101A and S101B are processes for the user U to input data into the software application A e.g. as exemplified in FIG. 7.

Of course, the user U can start at step S101A if they wish but, at some point, S101B needs to be done as well, or have been done already, otherwise the collaboration process will not be complete and the user would not be able to perform step S106. Alternatively if equivalent collaboration data for dry substance Y is available, the user can input this information straight into software application A without performing step 100 (S100A, S100B & S100C).

Steps S100 (A, B and C), S101A and S101B thus make up the full collaboration process before the user can start entering or selecting their dry substance Y requirements etc. (e.g. step S106 and after) relating to the actual measurement information that they require.

Step 200 enables a user (User U) to share any collaboration data relating to a dry substance Y with user Z. User Z could input or upload collaboration data into software application A and could proceed to step S106 and/or S101C without performing step S100 (A, B, C).

FIG. 7 represents a scenario in which a user wishes to measure a concentration level of an ingredient X in a dry substance Y or a weight serving size of dry substance Y (S10). The initial collaboration procedure (S100 from FIG. 6), if required, is conducted first. Then, in step S12, the user inputs to a software application A the name and net weight of the dry substance Y (S101A from FIG. 6). Additionally, for ingredient X concentration level measurements, the user inputs the ingredient concentration level relative to its actual weight and the actual weight relative to its ingredient concentration level (e.g. information provided from nutritional facts from food packaging). The “collaboration weight” of the dry substance as established from the collaboration process (S100 from FIG. 6) is also inputted by the user to the software application A (S101B from FIG. 6). The height of the measurable area of measuring device 10 needs to be established and recorded. This data can be incorporated into and/or selectable from the software application A or the user could manually input it. Advantageously, embodiments of the invention are not restricted to any one sized measuring device 10 or to any one sized height of measureable area. The height of the measurable area of the measuring device 10 does not include the overall height of the measuring device but only the height from the top outer edge of the bowl of the measuring device 10 to the top edge of the last marker M on the device (i.e. from top to bottom or vice versa). E.g. the total height of the device 10 may be 62.75 cm, but the ‘useable’ height is from the top edge of the device 10 to the top edge of the last marker M on the device—i.e. 50 mm.

The software application A performs some calculations at step S14 (S108A from FIG. 6). Here, the weight to ingredient X concentration ratio is calculated:

$$\frac{{weight}^{*}}{ingredient \times concentration}$$

The maximum ingredient X concentration content is calculated:

$$\frac{ingredient \times concentration}{{weight}^{*}} \times collaboration weight$$

The maximum ingredient X concentration content formula refers to the ingredient X concentration relative to the collaboration weight of dry substance Y in measuring device 10 (as discussed previously). * The “weight” is the actual weight of ingredient X concentration, taken from the specification of dry substance Y itself e.g. on foodstuff packaging/labelling. For example, 20 g of protein from dry substance Y may weigh 23 g.

The symbol ‘x’ refers to times or multiplied by sign.

The symbol ‘ [symbol] ’ or ‘/’ refers to the division sign (+).

The measurable area height to maximum ingredient X concentration content ratio is calculated:

$$\frac{measurable area height}{maximum ingredient \times concentration content}$$

The software application A automatically performs and calculates a series of data to store in a database using the above mentioned formulas (S108A from FIG. 6) and user inputted data (S101A, S101B from FIG. 6). Dry substance Y is now fully collaborated with the measuring device 10. Collaboration enables the density (and/or other physical properties) of the dry substance Y to be taken into consideration to provide for more accurate measurements of different dry substances when used with measuring device 10.

At step S16 (S106 from FIG. 6), the user inputs or selects the required concentration levels of ingredient X of dry substance Y. Here, the user selects saved data relating to the name of dry substance Y in the application software A and selects or enters data relating to the concentration level(s) required of ingredient X in dry substance Y.

The software application A then generates an output code at step S18 (S108B from FIG. 6). This is a data code (“output code XX”). Output code XX could be made up of several data variables. Output code XX denotes any data presented in any format that indicates to the user how much adjustment is required of the movable adjustable base 18 inside the measuring device body 12 that will give the user their required predetermined amount of ingredient X concentration of a dry substance Y or serving weight size of dry substance Y once it is filled inside the measuring device 10. The output code XX is calculated by taking a user inputted or selected ingredient X concentration level and multiplying that by the measurable area height to maximum ingredient X concentration content ratio described above.

As such, where a particular serving weight Y is required, the output code XX is:

User required Ingredient X Concentration Level x Weight to Ingredient X Concentration Ratio Where a particular ingredient X concentration level is required, the output code XX is:

User defined Ingredient X Concentration Level x Measurable Area Height to Maximum Ingredient X Concentration content ratio

For example, for the measuring device 10 as shown in FIGS. 1-5, if a user required 25 g of ingredient X concentration in dry substance Y and the software application A generated an output code XX of 2.5, the user would simply adjust the moveable adjustable base 18 in the measuring device 10 against the top edge of marker line M that is aligned against the number 2.5. The user then simply fills the measuring device 10 with the dry substance Y and this will give the user their predetermined 25 g of ingredient X concentration level in dry substance Y.

Output code XX can also be used to override the markings on the measuring device in order to achieve predetermined concentration level(s) of ingredient X in dry substance Y or serving weight size of dry substance Y. Using the above mentioned example output code XX could generate data that is greater than the maximum marking number that is on the measuring device. In this case the user can override the maximum marking number on the measuring device 10 so that the output code XX (e.g. 5.3) can still be achieved using any proven and reliable method so long that it gives the same end result. For example if the software application A generated an output code XX of 5.3 for 60 g of ingredient X concentration in dry substance Y, this can be achieved on the measuring device 10 with the user firstly aligning the movable adjustable base 18 against the marker line with the maximum marking number on the measuring device number (i.e. 5.0). The user then fills the measuring device 10 with the desired dry substance Y followed by adjusting the moveable adjustable base 18 to the marker line with number 0.3 against it on the device, empties the contents elsewhere and then completely fills the measuring device 10 with the same dry substance Y. In other words 0.3+5.0=5.3. 60 g of ingredient X concentration in dry substance Y will have been achieved.

Several different methods can be used determine output code XX so that it instructs or indicates to the user how much adjustment is required of the movable adjustable base 18 inside the measuring device 10 so that will give the user their predetermined amount of ingredient X concentration from dry substance Y once it is filled inside the measuring device 10. Where the output code exceeds the maximum measurement marker, the data can be indicated to be a multiple of full or partial scoops. E.g. if the output code XX is 7.5 the user can be informed that they need 5.0+2.5, or 2.5+2.5+2.5. An indicator for a full scoop 10 can be given as a numeral, written, graphical image or other symbol. E.g. an output code of 7.5 could be represented as 1-2.5, or F-2.5 (F denoting ‘full scoop’) for example. Where an output code is calculated that is not an exact multiple of the measurement increments, the software can round the output code to the nearest increment M.

To instead measure a weight serving size, the collaboration weight data (inputted by the user into the software application A) can be referred to as the maximum dry substance Y weight content in device 10. The measurable area height to maximum dry substance Y weight content ratio is calculated as follows:

$$\frac{Measurable area height}{Maximum dry substance Y Weight}$$

The software application A will automatically performs and calculates a series of data to store in a database using the above mentioned formulas (S108A from FIG. 6) and using the data inputted by the user (S101A, S101B from FIG. 6). Dry substance Y would be fully collaborated with the measuring device 10.

The software application A automatically performs and calculates a series of data to store in a database using the above mentioned formulas (S108A from FIG. 6) and user inputted data (S101A, S101B from FIG. 6).

The user then determines the serving weight size required of a dry substance Y (S106 from FIG. 6 and step S16 from FIG. 7). The user selects saved data relating to the name of dry substance Y in the software application A and selects or enters data relating to the desired serving weight size required of dry substance Y. The software application will generate output code XX as:

User defined serving weight size x Measurable Area Height to Maximum Dry Substance Y Weight Ratio

Instead of, or in addition to, a numerical output code XX, a visual output code may be used. For example, where the maximum measurable area height size marking on the device body 12 is 5.0, if the output code XX is 5.0, then a full scoop symbol, such as that shown in FIG. 8(c) can be used, where n is an integer number of full scoops (1 in the present example) and could be either an odd or even number and preferably the icon including an indication of the orientation of the handle 40 of the measuring device to be preferably positioned to the left. Where the output code is a partial scoop, the output code can be presented instead with an icon representative of a partial scoop, e.g. as shown in FIG. 8(a) or 8(b). For an output code that exceeds the equivalent of one full scoop but which is a non-integer multiple number of scoops, the full and partial indicators can be combined as in FIGS. 8(d) and 8(e). Preferably the icon includes an indication of the orientation of the handle 40, in order to indicate to the user which way round to use the measuring device 10 and thus whether to use the odd or even number against a marker line M. As such, in FIG. 8(a), the handle 40 of the measuring device 10 needs to be positioned to the right so the odd number increments are visible to the user. In FIG. 8(b), the handle 40 of the measuring device 10 needs to be positioned to the left so the even number increments are visible to the user. In FIG. 8(d) at least one full scoop (but could be many) and one partial scoop is required where the “n.n” part of the partial scoop measurement is an even number. In the example of FIG. 8(e) at least one full scoop (but could be many) and one partial scoop is required where the “n.n” part of the partial scoop measurement is an odd number.

The software can have additional functionality, e.g. further to benefit from the accuracy and consistency of the measuring device 10 in measuring predetermined amounts of concentration levels of ingredient X in dry substance Y or weight serving sizes from dry substance Y. For example, the software application A can be programmed to assist a user in making informed decisions before purchase of dry substance Y products. For example the software can:
Provide data on the maximum number of user defined servings of ingredient X concentrations that can be obtained in dry substance Y
Provide data on the maximum number of user defined serving weight sizes that can be obtained in dry substance Y
Provide data on cost effective solutions based on the user's consumption requirements of ingredient X concentrations in dry substance Y
Provide data on cost effective solutions based on the user's consumption requirements of servings in dry substance Y

Referring now to FIG. 9, the software application can calculate and generate:
Output code A data in relation to how long the dry substance Y product will last based on the users consumption needs of concentration levels of ingredient X or required weight serving sizes of dry substance products
Output code B data in relation to the average cost per serving based on the users consumption needs of concentration levels of ingredient X or required weight serving sizes of dry substance products
Output code C data based on which dry substance Y products from a retailer(s) will provide the user with the best value for money. This is achieved by comparing the dry substance Y products which will last the longest based on either the users consumption needs of concentration levels of ingredient X or required weight serving sizes of dry substance products with the lowest average cost per serving.

To maximise the number of servings of ingredient X concentrations and provide cost effective solutions based on the user's consumption requirements of dry substance Y products, the user inputs data into software application A as previously described in steps S101A and S101B in FIG. 6. Additionally the user inputs extra information relating to their consumption needs of ingredient X concentrations, the place of purchase (retailer) details and total cost relating to dry substance Y (step S101C, FIG. 6).

The information relating to the user's consumption needs includes the user's levels of ingredient X concentration(s) consumed or likely to be consumed from dry substance Y and data relating to how often the specified level of ingredient X concentration is consumed or required or likely to be consumed per day and/or per week. The user has a second option to specify another requirement of the level of ingredient X concentration consumed or likely to be consumed (relating to the same dry substance Y product) and to input or select data relating to how often the specified level of ingredient X concentration is consumed or required or is likely to be consumed per day and/or per week.

The software performs various calculations including some similar to those described above, and additionally to calculate the output codes A, B and C (step S114, FIG. 6).

Output code A data reveals how long the dry substance Y product will last based on the users consumption needs of one and/or two specified ingredient X concentration levels (referred to as user consumption period).

Output code B data reveals the average cost per serving based on the users consumption needs of one and/or two specified ingredient X concentration levels relating to the dry substance Y.

Output code C data reveals a rating mark based on the calculated data for how long the dry substance Y product will last based on the users consumption needs of one and/or two specified ingredient X concentration levels and the data for the average cost per serving based on the user's consumption needs of one and/or two specified ingredient X concentration levels relating to the dry substance Y. The rating mark is used to compare the rating marks against other data entries inputted by the user in the software application A. The software application will sort the rating marks for each data entry from the highest rating mark data to the lowest rating mark data. The data entry with the most highest rating mark indicates the most cost effective dry substance Y product for the user based on their consumption needs of ingredient X concentration relating to a dry substance Y product and the total price paid or likely to be paid for that dry substance Y product from the place of purchase (e.g. retailer).

A low rating mark indicates a less cost effective dry substance Y product for the user based on their consumption needs of ingredient X concentration relating to a dry substance Y product and the total price paid or likely to be paid for that dry substance Y product from a retailer for example.

The software application can sort and display data entries based on the highest to lowest rating marks, average cost per servings and user consumption periods and vice versa.

Output codes A, B and C provides the user with valuable data which can be particularly useful for the consumer in deciding which place of purchase and which dry substance Y product best meets their needs as long as the dry substance Y product is used with the measuring device and the software application A. The software can calculate how to maximise the number of user defined serving weight sizes in dry substance Y and provide cost effective solutions based on the user's consumption requirements of servings in dry substance Y using the software application and the measuring device 10. The user inputs data into software application A as previously described in steps S101A and S101B in FIG. 6 (but excluding the ingredient X concentration amount and its relative actual weight data). Additionally the user inputs extra information relating to their serving size consumption needs, place of purchase (retailer) details and total cost relating to dry substance Y (step S101C, FIG. 6).

The information relating to the user's serving size consumption needs relates to how often the specified weight size of dry substance Y is consumed or likely to be consumed per day and/or per week. The user has a second option to specify another serving weight size requirements of the same dry substance Y that is consumed or likely to be consumed per day and/or per week. The software is programmed to perform various calculations including some similar to those described earlier, and as above to calculate the output codes A, B and C (S114, FIG. 6).

The software may be accessible by a user on any appropriate computing or processing device such as a mobile phone, wearable, watch, tablet, laptop or other personal electronic and/or computing device. The software may be in the form of an application (app) stored on the user's device and/or on a remote server. Data that is required to be stored in the software application A may be stored on a local and/or central database and on the user's device or on a remote server. Additionally data may be stored offboard in a separate storage area, transmitted wirelessly or wired from the user's device. The user may manually input readings provided by the weighing device or scale, or the computing or processing device may be connected wirelessly or wired to the scale, which may be integral with the measuring device 10 or separate.

In use, a user can download and install the software application on a device e.g. from an online app store e.g. iTunes store or Google Play, depending on the type of device they have. The software app may be installed locally on the user's device, but it is also possible that the app may instead be installed on a remote server.

In an embodiment, before the user can use the software app, the user needs to input some registration details, such as name, email address and an identifier e.g. a serial number or code of the measuring device. These information details may then be transmitted to a remote server or central database which can check the credentials accordingly and, if the checks are clear, the software app will proceed to a user log-in interface. The initial registration/unlocking may take place on a remote server using a website. If each device has a serial number attached to it, when a user downloads the app, the user may be required, as part of the registration set-up process, to input that serial number along with their first name, last name and email ID. If the credentials pass, the user can be prompted to log in with their credentials e.g. a social media account or email address (such as facebook, twitter or google mail), and with or without a serial number or code of the measuring device before it will unlock the app and give the user full access. The user's log-in credentials (such as the email address or serial number) can be verified and checked against the stored data (e.g. the user's email address and serial number from their registration) from the remote server to ensure such data matches before verifying the users email or social media account login credentials. Without the verification checks and valid log-in credentials, the software can remain locked. User registration or set up credentials may be saved on a remote server.

After that, the software app and the calculations performed, data inputted and storage of saved data as described above takes place locally on the user's device. The software app may have a local database. The user may however backup and restore data, or share saved data with other users remotely (e.g. on Google drive). Alternatively, the sharing of a user's collaboration data (storing, retrieving, exporting and importing) between users could also be done via a remote server PC (at home/office), a website, web forum, shared web hosting, virtual private servers or dedicated servers or even semi dedicated servers (all come under remote servers). These may be convenient options e.g. if storage of data becomes more complex overtime or an alternative is needed.

A number of tests have been performed using the measuring device 10 along with the associated software application and a digital weighing scale in order to ascertain and verify the improved accuracy and consistency of measuring various ingredient X concentrations such as protein and carbohydrate serving sizes and serving weight sizes of dry substance Y such as protein and carbohydrate nutritional supplement powders or wholefood grains. The tests were carried out at different intervals. The data was inputted into the software application and various output code XX data (i.e. precision mark codes). To test the improved accuracy and consistency of different levels of protein and carbohydrate serving sizes as selected by the tester for a particular protein or carbohydrate supplement, a comparison was made between the serving weight of different levels of protein or carbohydrate concentration serving sizes in measuring device 10 (excluding the weight of the device itself) against the serving weight data of the selected protein or carbohydrate serving size from software application A relating to a dry substance Y product. A digital weighing scale was used to weigh the actual serving weight of the protein or carbohydrate serving size in measuring device 10 using the method similar to the collaboration process as discussed earlier and using the methods as described herein. A comparison was made between the user's selected required serving size from software application A and the actual measured serving size of dry substances.

The weight of the serving size of ingredient X concentration of the dry substance Y in measuring device 10 is measured using a digital weighing scale by adjusting the plunger 20 inside the device body 12 to the relevant marking according to generated output code XX from software application A and taring or zeroing the weight of the device 10 each time followed by putting the contents of dry substance Y inside the device and then weighing the device each time accordingly. A total sum of the serving weight was recorded each time and once done, the actual protein serving size (ingredient X concentration) needs to be ascertained which is relative to the total sum of the serving weight. To do this the ingredient X concentration is calculated as follows:

$$\frac{Ingredient \times concentration}{Weight} \times Serving weight = Ingredient \times concentration$$

The ingredient X concentration over weight refers to data that is taken from the dry substance Y specifications itself. In the example used below it was the nutritional data taken from the protein supplement product. The weight being relative to the ingredient X concentration. The serving weight being the total sum of the serving weight measured on the scale.

The actual measured data is then compared with the data from the software application A relating to the same dry substance product (i.e. ingredient X concentration amount selected by the user and the serving weight data relative to that ingredient X concentration level which is also calculated by the software application). The serving weight data is calculated using the serving weight Y formula as described earlier.

User required Ingredient X Concentration Level×Weight to Ingredient X Concentration ratio=Serving Weight Y

In one test for example, 7 g was the total actual serving weight of the protein serving size of a protein supplement powder (Everyday Whey Protein Concentrate) using the digital weighing scale for a predetermined amount of 5 g protein serving size.

82 g (protein per serving)/100 g (weight relative to 82 g protein per serving)=0.82. 0.82×7 (Actual Serving Weight reading on Scale D)=6 g (Ingredient X Concentration). The actual protein serving size was 6 g.

5 g (User required protein serving size)×1.22 (100 g/82 g)=6 g (serving weight relative to the 5 g protein serving size).

Actual protein serving size measured from protein supplement powder: 6 g

Protein serving size from protein supplement powder selected in software application: 5 g

Difference: +1 g.

In this example, the tester selected 5 g protein serving size and the software application A gave a serving weight data as 6 g. The output code XX was generated. The test outcome showed the actual serving weight reading on scale was 7 g and the actual measured protein serving was 6 g. The difference between the actual measured protein serving size and the selected protein serving size from the software app was 1 g. The test shows a very low minute difference and demonstrates a minimal waste effect of dry substance Y (i.e. Everyday Whey Protein Concentrate) using the measuring device. When the tester selected 100 g protein serving size, the software application A gave a serving weight data as 122 g. The output code XX was generated. The test outcome showed the actual serving weight reading on the scale was 124 g and the actual protein serving was 101.68 g (102 g). The difference between the actual protein serving size and the selected protein serving size was 1.68 g (2 g). The smaller the difference between the selected and actual protein serving size, the lower the wastage effect of the dry substance Y and the greater the accuracy and consistency of the measuring control of the present device.

In all tests conducted on various different dry substances (i.e. food sources) with different levels of serving sizes, the differences between the actual and selected ingredient X concentrations were very low i.e. protein or carbohydrate concentration serving sizes. This demonstrates a minimal (or zero in some cases) wastage effect of ingredient X concentrations of dry substance Y. To ensure consistency of each protein and carbohydrate serving size test conducted, when the measuring device was filled with the desired dry substance contents, the measuring device was levelled off from the top using the inner flat surface area of the product container/packaging itself. Additionally this also demonstrates the accuracy and consistency of the measuring device 10 when used to select multiple levels of ingredient X concentrations (protein and carbohydrate serving sizes) with dry substance Y (protein and carbohydrate supplement powders). Similar low differences were observed in tests for serving weight size.

Measuring device performance tests against conventional plastic scoops were also performed, to demonstrate the effectiveness of the measuring device 10 with regard to the accuracy and consistency of measuring ingredient X concentrations relating to dry substance Y. Due to the limitations of conventional plastic scoops, it is not possible to test any level of ingredient X concentrations (protein or carbohydrate serving sizes). This is because conventional plastic scoops come in fixed size measures and are only designed to give an approximate measure of a serving as per the specified manufacturers suggested serving size on the dry substance Y product label specifications.

In the testing only a like for like testing was carried out in order to ensure a fair and consistent test trial. In an example, the dry substance Y is ‘Precision Engineered Whey Protein—Vanilla Flavour’. The suggested protein serving size (from the product label) is 24 g serving—18.5 g protein (1 levelled scoop—70 cc provided with product). According to the product label one levelled scoop using the provided 70 cc scoop with the product would give 18.5 g of protein serving. Two scoops should in theory provide 37 g of protein serving, three scoops 55.5 g of protein serving and four scoops 74 g of protein serving. A like for like test would be where a test is carried out when testing 1, 2, 3, 4 etc. levelled scoops with a conventional plastic scoops providing the protein or carbohydrate serving size equating to a whole number only (using the manufacturer suggested protein or carbohydrate serving size data only).

In an exemplary test, for two conventional scoops of the powder, the actual protein serving size was found to be 46 g (i.e. +9 g from the theoretical amount) and for four conventional scoops the actual protein serving size was found to be 93 g (i.e. +19 g from the theoretical amount). It can therefore be concluded that, with conventional plastic scoops, the differences between the actual and selected protein serving sizes are high and leads to a higher wastage effect of dry substance Y. Additionally the consumer would not be getting close to the required level of protein serving they wish, which can lead to other problems such as higher protein consumption than necessary (which can have knock on medial effects in some circumstances). The greater the number of scoop repetitions the greater the varied difference between the actual and selected protein serving sizes and the greater the wastage and inconsistency and inaccuracy of the measure.

Using the measuring device 10 of an embodiment of the present invention, however, for a number of scoops of the same powder (precision marking 1.3 on measuring device 10) equivalent to two conventional scoops, the actual protein serving size was found to be 37 g (i.e. the same as the theoretical amount (0 g deviation)). For a number of scoops (precision marking 2.7 on measuring device 10) equivalent to four conventional scoops the actual protein serving size was found to be 76 g (i.e. +2 g from the theoretical amount). As such, in the tests performed using the present measuring device 10, the differences between the actual and selected protein serving sizes are very low. This demonstrates a minimal (or zero in some cases) wastage effect of dry substance Y. Additionally this also demonstrates the accuracy and consistency of the measuring device 10 when used to select multiple ingredient X concentrations of dry substance Y compared to conventional plastic scoops.

The test data also highlights examples of the misrepresentation and inaccuracies of the data specified on product labels for dry substances i.e. protein supplement powders that come with conventional plastic scoops. This further demonstrates the inaccuracies and inconsistencies of measures using these conventional plastic scoops. On the other hand the test data showed that the present measuring device meets the data as specified on the product labels in relation to servings per container.

Of course, whilst aspects and embodiments of the invention have been described in connection with measuring dry substances, it may also be possible to use the device 10 to measure wet substances (i.e. anything that is not “dry” as discussed above). A rigid or flexible sealing means could be provided around one or more edges of the plunger base 18 if required, although the one or two-part rigid construction described above is advantageously simple and convenient.

From reading the present disclosure, other variations and modifications will be apparent to the skilled person. Such variations and modifications may involve equivalent and other features which are already known in the art of wireless communication, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and any reference signs in the claims shall not be construed as limiting the scope of the claims.

1. A computer-implemented method for obtaining a setting for measurement of a substance using an adjustable measuring device, the method comprising:
receiving user input relating to a required amount of an ingredient X concentration level or a serving size of a dry substance Y;
calculating a setting for the adjustable measuring device based on the received user input and stored information relating to calibration of the device with the substance; and
outputting or displaying data relating to the setting to be used for the adjustable measuring device.

2. The method of claim 1, wherein the user input comprises one or more of the name of a dry substance Y, the net weight of the substance Y, a calibration weight, the ingredient X concentration level and its relative actual weight.

3. The method of claim 2, further comprising inputting or selecting a required weight serving size of substance Y or a required concentration level of ingredient X in substance Y.

4. The method of claim 1, wherein outputting or displaying the data relating to the setting to be used for the adjustable measuring device comprises:
outputting or displaying a value corresponding to a measuring mark that is provided on the adjustable measuring device; and/or
outputting or displaying a symbol indicative of an orientation in which the measuring device must be used.

5. The method of claim 4, wherein outputting or displaying a symbol also comprises indicating whether the adjustable measuring device should be fully or partially filled.

6. The method of claim 4, wherein outputting or displaying the data relating to the setting to be used for the adjustable measuring device comprises outputting or displaying a plurality of values and/or symbols where the serving weight size amount or ingredient X concentration required of substance Y equates to less than or more than one full measuring device.

7. The method of claim 1, further comprising calibrating said adjustable device by:
receiving user input relating to a dry substance Y, the user input comprising one or more specifications of the substance Y and a calibration weight of a predetermined amount of the substance calculated by zeroing a weight of the measuring device with a weighing device or scale when empty, and then weighing said adjustable device when filled to a predetermined level with the substance, or by determining the weight difference between said adjustable device with said adjustable device when filled to a predetermined level with the substance.

8. A system comprising an adjustable measuring device for measuring an amount of a substance, the adjustable measuring device comprising:
a hollow body for receiving contents to be measured;
a plunger frictionally receivable within the body and moveable in an axial direction within the body;
wherein the plunger is formed of a rigid material and comprises a major, flat surface perpendicular to the axial direction, and at least a portion of the side wall or walls of the plunger are parallel with the inner surface or surfaces of the body such that the flat surface of the plunger remains perpendicular to the axial direction as it is moved with respect to the body; and
a processing device configured to execute the method of claim 1.

9. The system of claim 8, wherein the body and plunger are cylindrical.

10. The system of claim 8, wherein the plunger is formed of one or more rigid plastics materials.

11. The system of claim 8, wherein the plunger is of a unitary construction or comprises a body having a cavity and an insert receivable within the cavity and, optionally or preferably, wherein the outer surface of the plunger comprises one or more formations configured to provide an interference fit with the inner surface or surfaces of the device body to facilitate movement in the axial direction and, optionally or preferably, wherein the one or more formations comprise one or more ridges and/or grooves and/or side walls along the outer surface thereof extending in the axial and/or perpendicular and/or other direction.

12. The system of claim 8, wherein the adjustable measuring device further comprises a handle.

13. The system of claim 12, wherein the adjustable measuring device further comprises a first set of measuring marks on a first portion of the exterior of the body and a second set of measuring marks on a second portion of the exterior of the body, the first and second portions being diametrically opposite each other and either side of the handle.

14. The system of claim 13, wherein the first set of measuring marks comprise measurements of even numbers and the second set of measuring marks comprise measurements of odd numbers and, optionally or preferably, wherein the measuring marks each comprise a line perpendicular to the axial direction, the lines each having a predefined thickness and/or separation.

15. The system of claim 8, further comprising a display means and/or user interface for displaying the outputted data and for enabling input by a user.

16. The system of claim 8, wherein the system is implemented on a personal computing device such as a mobile phone, wearable, watch, tablet or laptop.

17. (canceled)

18. (canceled)

19. An adjustable measuring device for measuring an amount of a substance, the adjustable measuring device comprising:
a hollow body for receiving contents to be measured, the body having a first set of measuring marks on a first portion of the exterior of the body and a second set of measuring marks on a second portion of the exterior of the body, the first and second portions being diametrically opposite each other wherein each measuring mark represents a distance of the measuring mark from a top edge of the hollow body with the first set of measuring marks providing only even numbers and the second set of measuring marks providing only odd numbers; and
a plunger frictionally receivable within the body and moveable in an axial direction within the body;
wherein the plunger is formed of a rigid material and comprises at least one side wall and a flat surface perpendicular to the axial direction, wherein at least a portion of the at least one side wall is parallel with the inner surface or surfaces of the body such that the flat surface of the plunger remains perpendicular to the axial direction as it is moved with respect to the body.
